(19) United States
(12) Patent Application Publication
(10) Pub. No.: US 2018/0100616 A1
(43) Pub. Date: Apr. 12, 2018

(54) MOBILE ELECTRONIC DEVICE CARRYING APPARATUS

(71) Applicant: David Streater, McKinney, TX (US)

(72) Inventor: David Streater, McKinney, TX (US)

(21) Appl. No.: 15/728,094

(22) Filed: Oct. 9, 2017

Related U.S. Application Data
(60) Provisional application No. 62/405,722, filed on Oct. 7, 2016.

(51) Int. Cl. F16M 13/00; A45F 5/00

(52) U.S. Cl. CPC F16M 13/00; A45F 5/00

(57) ABSTRACT

The present invention relates to a carrying apparatus for mobile electronic devices providing increased protection and increased ease of manipulation of the mobile device to which it is affixed while allowing full functionality of the mobile device. The combination of a first gripping device, a second gripping device, and a connecting device allows for the retention of a mobile electronic device in a fashion which increases the protection of the device, allows single handed use, and provides multiple viewing angles when rested upon a surface.

This application claims the benefit of U.S. Provisional Patent Application 62/405,722 entitled “MOBILE ELECTRONIC DEVICE CARRYING APPARATUS” filed on Oct. 7, 2016, the entire contents of which are incorporated herein by reference in its entirety for all purposes.

### FIELD OF THE INVENTION

The present invention relates to a carrying apparatus for mobile electronic devices providing increased protection and increased ease of manipulation of the mobile device to which it is affixed while allowing full functionality of the mobile device.

### BACKGROUND OF THE INVENTION

Protective apparatus are generally known in the field surrounding mobile electronic devices for the protection of such devices including smart phones, tablet computers, laptops and other associated mobile electronic devices.

As individual interaction with mobile electronic devices increases, so does one's manipulation and handling of the mobile electronic device. The increased manipulation and handling of a mobile electronic device also increases the chances of dropping or damaging the mobile electronic device. The high cost associated with mobile electronic devices motivate users to protect their financial investment in the mobile electronic devices. There are insurance options to users, however these options are often prohibitively expensive and do not address the inconveniences associated with a damaged or inoperable mobile electronic device. Many users have adopted the use of a protective device, often referred to as a “case.” A case, attached to a mobile electronic device, offers increased protection from scratching, impacts and sometimes even water damage.

A growing need surrounding mobile electronic devices relates to the manipulation and handling of such devices. Some users prefer a one-handed use of such devices holding the mobile electronic device between the palm of their hand and their outstretched fingers. Trends surrounding mobile electronic devices, such as smart phones, has resulted in the production of larger and more unwieldy mobile electronic devices. These larger mobile electronic devices are less accommodating for one-handed use, as many users are accustomed to, and are more subject to accidental dropping. The addition of an enclosure or case to a mobile electronic device, results in an even larger form factor, compounding the problem surrounding the problem of handling a large mobile electronic device. There exists a need for an apparatus providing protection to mobile electronic devices while providing an increased level of manual control when manipulating and handling a mobile electronic device.

### SUMMARY OF THE INVENTION

Aspect of embodiments of the present invention as disclosed herein surrounding an apparatus configured to attach to a mobile electronic device include: providing increased protection, increasing manual control, and/or provide freestanding viewing usability of an existing mobile electronic device.

Certain existing solutions, such as U.S. Pat. No. 7,551,458 (the '458 Patent”) to Carnevali, aim to provide mounting provisions to a variety of existing mobile electronic devices using a rigid jaw structure to retain a mobile electronic device for mounting to a secondary structure. Such solutions as the '458 Patent use spring-loaded clamping mechanisms to provide extendable structures which require many small parts. The use of small parts require additional manufacturing and assembly, increasing the overall cost of the apparatus. Additionally, an increased number of small parts are prone to breakage due to mismatched tolerances and wear-and-tear through frequent use. Further still, such solutions as the '458 Patent used in conjunction with a mobile electronic device fail to provide an increased level of manual control when a user is manipulating and handling the mobile electronic device.

Other existing technologies aim to provide better manual control of mobile electronic devices when a user is manipulating or handling it by adhering features to the back-side of a mobile electronic device. Such existing solutions include U.S. Pat. No. 8,528,798 to Chen (“the '798 Patent”); U.S. Pat. No. 9,300,346 to Hirsch (“the '346 Patent”); U.S. Patent Publication No. 2009/0270050 to Brown (“the '050 Publication”); U.S. Patent Publication No. 2011/0266316 to Ghalib, et al. (“the '316 Publication”); and U.S. Pat. No. 8,550,317 to Hyseni (“the '317 Patent”), all of which are incorporated in their entirety by reference herein.

Solutions as detailed in the '798 Patent, the '317 Patent, '316 Publication, and the '050 Publication surround the fixation of flexible loops on the back-side of a mobile electronic device to allow a user to place one or more fingers through flexible loops for increased manual control of the mobile electronic device. Where such solutions fail surrounds the need to manipulate these flexible loops in order to properly dispose one or more fingers through the flexible loops. Such solutions surrounding the use of flexible loops are unable to rest on a surface with the back-side parallel to the surface on which it rests. Furthermore, being affixed to the back-side of mobile electronic device using adhesives, such solutions cannot be easily detached and reattached without potential damage to the flexible loops, leaving adhesive residue on the back-surface of the mobile electronic device. In some scenarios the adhesive used to attach such flexible loops mars or permanently damage the surface of the mobile electronic device. Further still, such solutions fail to provide increased protection in case a user drops the mobile electronic device.

Solutions such as the '317 Patent and the '346 Patent attempt to address the problem surrounding adding manual control of a mobile electronic device while allowing the mobile electronic device to rest with the back-surface of the mobile electronic device parallel to the surface on which it rests. These solutions provide for a flexible and extendable features for disposing one or two fingers through retractable flexible features affixed to the mobile electronic device through the use of a secondary mounting device. Where such solutions fall short surrounds the difficulty and complexity surrounding the installation and removal of such an apparatus. Furthermore, the need for an added apparatus to attach the flexible features creates increased bulk for an already unwieldy apparatus.

Embodiments of the invention as disclosed herein surround a carrying apparatus for the increased manual control and increased protection of a mobile electronic device. An aspect of certain embodiments of the present invention is to provide multiple operative angles for hands-free operation and viewing of a mobile electronic device. It will be appreciated that hands-free operation of a mobile electronic device surrounds the normal use of a mobile electronic device without the need to handle the mobile electronic device. Multiple operative angles allows a user to operate the mobile electronic device with one hand, two hands, or rest the mobile electronic device on a surface for viewing and hands-free operation. Yet another aspect of the present invention surrounds ease of installation and removal of a mobile electronic device without the risk of marring or permanently damaging the mobile electronic device or interfering with buttons on the external surfaces of the mobile electronic device.

These and other advantages will be apparent from the disclosure of the inventions contained herein. The above-described embodiments, objectives, and configurations are neither complete nor exhaustive. As will be appreciated, other embodiments of the invention are possible using, alone or in combination, one or more of the features set forth above or described in detail below. Further, this Summary is neither intended nor should it be construed as being representative of the full extent and scope of the present invention. The present invention is set forth in various levels of detail in this Summary, as well as in the attached drawings and the detailed description below, and no limitation as to the scope of the present invention is intended to either the inclusion or non-inclusion of elements, components, etc. in this Summary. Additional aspects of the present invention will become more readily apparent from the detailed description, particularly when taken together with the drawings, and the claims provided herein.

### BRIEF DESCRIPTION OF THE DRAWINGS

FIG. 1—A side-view of an embodiment of a gripping device.

FIG. 2A—A side-view of an embodiment of a gripping device.

FIG. 2B—A side-view of an embodiment of a gripping device.

FIG. 3—A side-view of an embodiment of a gripping device.

FIG. 4—A side-view of an embodiment of a gripping device.

FIG. 5A—A side-view of an embodiment of a gripping device.

FIG. 5B—A side-view of an embodiment of a gripping device.

FIG. 6A—A side-view of an embodiment of a connecting device.

FIG. 6B—A side-view of an embodiment of a connecting device.

FIG. 6C—A perspective-view of an embodiment of a gripping device.

FIG. 7A—A perspective-view of an embodiment of a mobile electronic device carrying apparatus.

FIG. 7B—A perspective-view of an embodiment of a mobile electronic device carrying apparatus.

FIG. 8A—A dimensioned side-view of certain embodiments of the present invention.

FIG. 8B—A dimensioned side-view of certain embodiments of the present invention.

### DETAILED DESCRIPTION

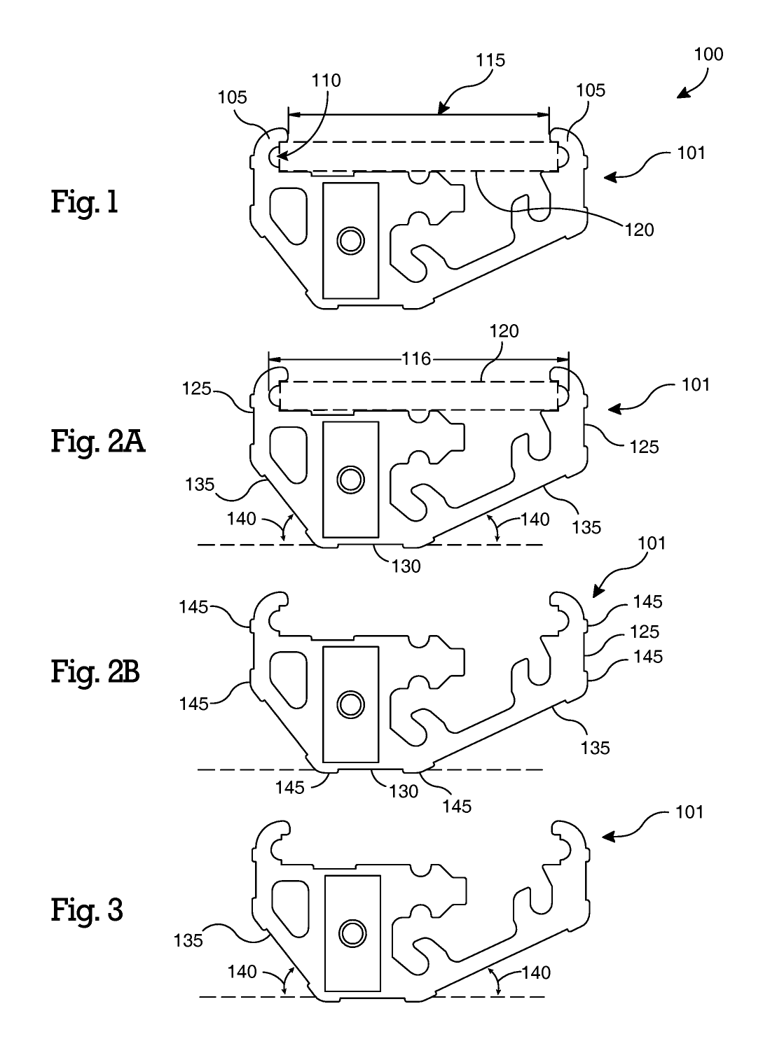

Embodiments of the invention as disclosed herein surround a mobile electronic device carrying apparatus for the attachment to a mobile electronic device. Certain embodiments of mobile electronic device carrying apparatus 100, as seen in FIG. 1, comprise a gripping device 101 further comprising a first gripping element 105 and a second gripping element 105. A gripping element 105 of certain embodiments further comprises a gripping recess 110. Certain embodiments comprising a first gripping element 105 and a second gripping element 105 are configured such that the first and second gripping elements 105 are disposed horizontally from each other. Thus, corresponding surfaces of each recess 110 are parallel to each other. In such embodiments, a gripping element distance 115 is configured to be approximately equal to or less than the distance from a first edge of a mobile electronic device 120 to a second opposing edge of the mobile electronic device 120.

In certain embodiments, shown in FIG. 2A, a maximum recess distance 116 surrounds the maximum distance between the outward extents of a recess 110 between a first gripping element 105 and a second gripping element 105 of a first gripping device 101. Although a maximum recess distance 116, typically equal to or greater than a gripping element distance 115 (shown in FIG. 1) is in keeping with the scope and spirit of the present invention, it will be appreciated that some configurations are more desired than others. In certain embodiments, a maximum recess distance 116 is between 0.0635 cm (0.25 in) and 1.905 cm (0.75 in) greater than the gripping element distance 115 (FIG. 1).

Certain embodiments of the invention, seen in FIG. 2A, comprise a gripping device 101 further comprising viewing surfaces allowing a mobile electronic device 120 attached to the gripping device 101 to be disposed at an angle for viewing. Certain embodiments comprise a perpendicular viewing surface 125, allowing the mobile electronic device 120 to be disposed perpendicular to a surface such as a table top. Some embodiments comprise a parallel viewing surface 130, allowing the mobile electronic device 120 to be disposed parallel to a surface such as a table top. Other embodiments comprise an angled viewing surface 135, allowing the mobile electronic device 120 to be disposed at viewing angle 140 to a surface such as a table top. Some embodiments comprise angled viewing surfaces 125, allowing the mobile electronic device 120 to be disposed at an angle to a surface such as a table top.

Certain embodiments of the invention, as seen in FIG. 2B, comprising a gripping device 101 further comprise standoffs 145 coincident with a viewing surface such as a parallel viewing surface 130, angled viewing surface 135, or perpendicular viewing surface 125. A standoff 145 in such embodiments serves to provide spacing between the gripping device 101 and a surface on which it rests. In such embodiments, a standoff 145 comprises a feature disposed at a distal end of a viewing surface. It will be appreciated that where a first viewing surface and a second viewing surface intersect, as seen in FIG. 2B, a standoff 145 serves as a standoff for both the first viewing surface and the second viewing surface.

Certain embodiments of the invention, seen in FIG. 3, comprise a gripping element 101 having a first angled viewing surface 135 and a second angled viewing surface 135. In certain embodiments the viewing angle 140 of the first viewing surface 135 is different than the viewing angle 140 of the second viewing surface 135. It will be appreciated that in other embodiments, the viewing angle 140 of a first viewing surface 135 is equal to the viewing angle 140 of a second viewing surface 135.

In certain embodiments, shown in FIG. 2A and FIG. 3, although an angled viewing surface 135 having a viewing angle 140 between 0°-90° is in keeping with the spirit and the scope of the present invention, it will be appreciated that certain viewing angles 140 are more desirable than others. In certain embodiments, a first angled viewing surface 135 comprises a viewing angle 140 between 39°-52° and a second angled viewing surface 135 comprising a viewing angle 140 between 25°-30°. More preferably, certain embodiments a first angled viewing surface 135 having a viewing angle 140 between 39°-52° and a second viewing surface comprising a viewing angle 140 between 25°-30°.

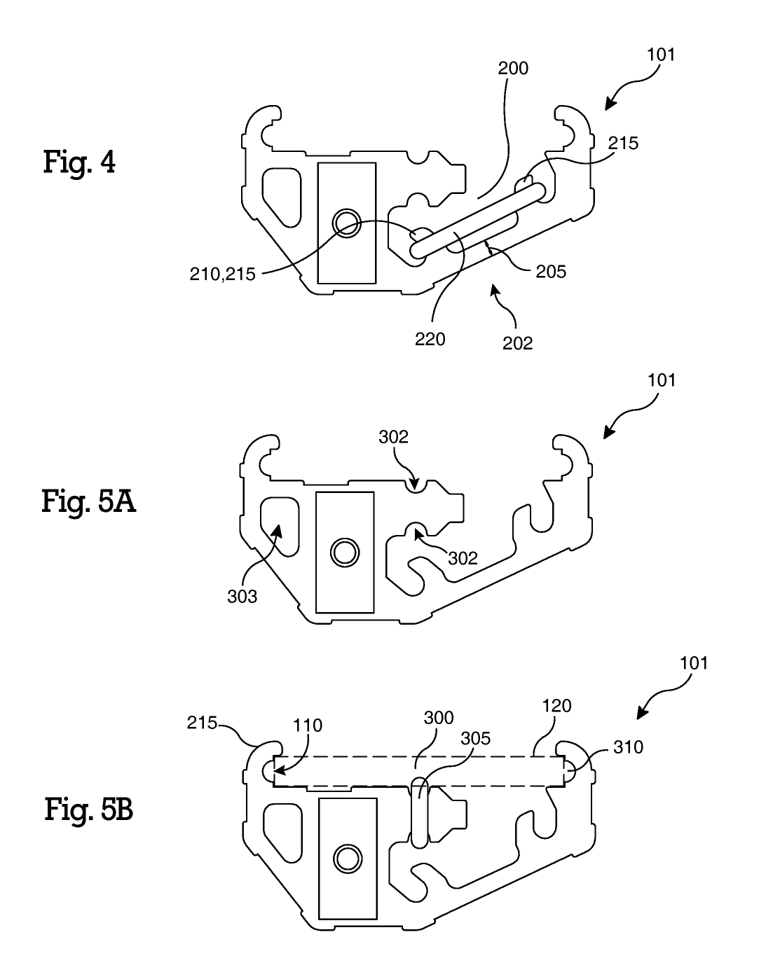

Certain embodiments of the invention, as shown in FIG. 4, comprise a gripping device 101 having a flex relief 200 cut through the profile of the gripping device 101 to provide added flexibility to the gripping device 101. It will be appreciated that a maximum flex portion 202 is typically located coincident with a minimum material thickness 205. In certain embodiments, the flex relief 200 further comprises a tensioning feature 210 designed to provide tension across the flex relief 200. The tensioning feature 210 allows an increase in deflection or magnitude of deflection provided by the flex relief 205, while maintaining structural rigidity to constrain a mobile electronic device within the apparatus. Certain embodiments of a tensioning feature 210 have a plurality of hook features 215. In such embodiments a first hook feature 215 is disposed to one side a maximum flex portion 202, and a second hook feature 215 is disposed to the opposite side of the maximum flex portion 202. In such embodiments, a tensioning device 220 spans between the first hook feature 215 and the second hook feature 215. A tensioning device 220 of certain embodiments comprises a toroidal form, but is not limited to such forms. It will be further appreciated that a tensioning device 220 comprises a material such as, but not limited to, polytetrafluoroethylene (PTFE), spring metal, nitrile, neoprene, ethylene propylene diene monomer (EPDM) rubber, fluorocarbon based materials or materials known to those skilled in the art able to provide tension between features. It will be appreciated that a tensioning device 220 comprising other devices known to those in the art to provide tension between two features is in keeping with the spirit and scope of the present invention.

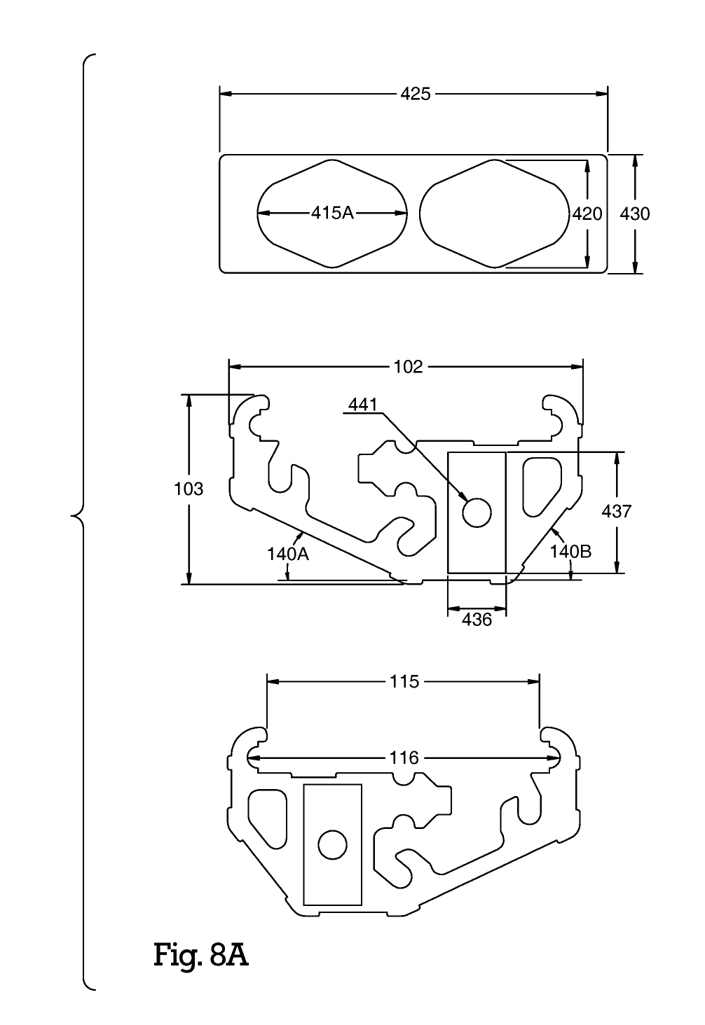

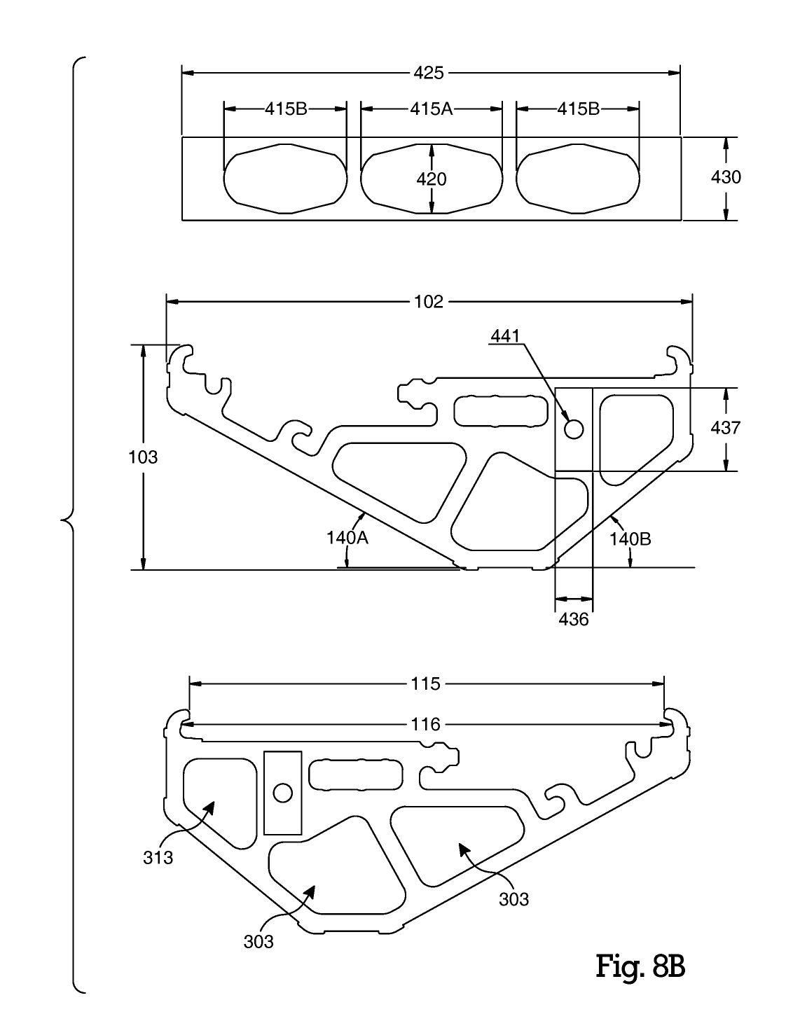

Certain embodiments of the present invention, shown in FIG. 5A, comprise a gripping device 101 having a cut-out 303, which serves to reduce the weight of a gripping device 101. In certain embodiments, shown in FIG. 8B, a gripping device 101 comprises a plurality of cut-outs 303.

Certain embodiments of the invention as seen in FIG. 5A, comprise a gripping device 101 having a recess 110 which further comprises a protrusion recess 310. A protrusion recess 310, provides clearance beyond the profile of the mobile electronic device 120 preventing the accidental actuation of a protrusion such as buttons or a switch on the mobile electronic device 120. In other embodiments, a protrusion recess 315 is coincident with a surface of a gripping device 101 which interfaces with a back surface of a mobile electronic device 120. This provides clearance and prevents interference between the gripping device 101 and a protrusion from a surface of the mobile electronic device 120. It will be appreciated that some mobile devices 120 for use with the invention have a camera or other device protruding beyond a surface of the mobile electronic device 120. It will be further appreciated that a protrusion recess 315 of certain embodiments is configured to provide clearance for a camera or other device specific to a particular mobile electronic device 120.

Certain embodiments of the invention, as seen in FIG. 5A and FIG. 5B, comprise a gripping device 101 further comprising an anti-slide feature 300 intended to interface between the gripping device 101 and a mobile electronic device 120. The anti-slide feature 300 serves to limit sliding between a mobile electronic device 120 and a gripping device 101. In certain embodiments, an anti-slide feature 300 is configured such that an anti-slide device 305, is disposed to span across a first anti-slide radius 302 and a second anti-slide radius 302, and interface with a surface of a mobile electronic device 120. The anti-slide device 305 comprises a material to provide frictional retention by interfacing between a surface of a mobile electronic device 120 and a gripping device 101. In the current embodiment as presented, the anti-slide device 305 is a toroidal device, but is not limited to such embodiments. It will be further appreciated that an anti-slide device 305 comprises a material such as, but not limited to, polytetrafluoroethylene (PTFE), nitrile, neoprene, ene propylene diene monomer EPDM) rubber or fluorocarbon based materials

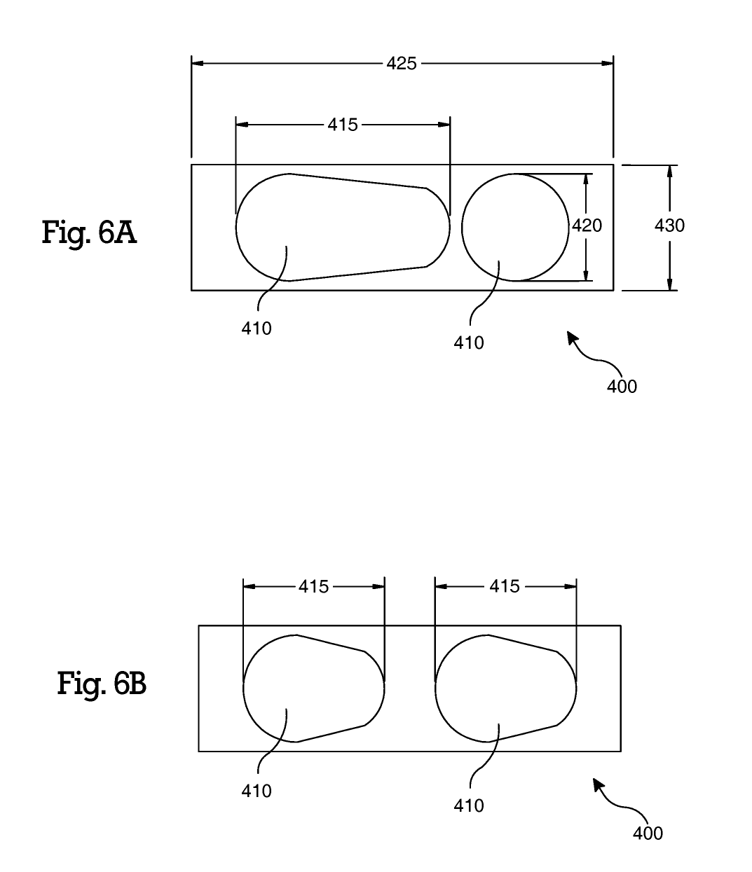

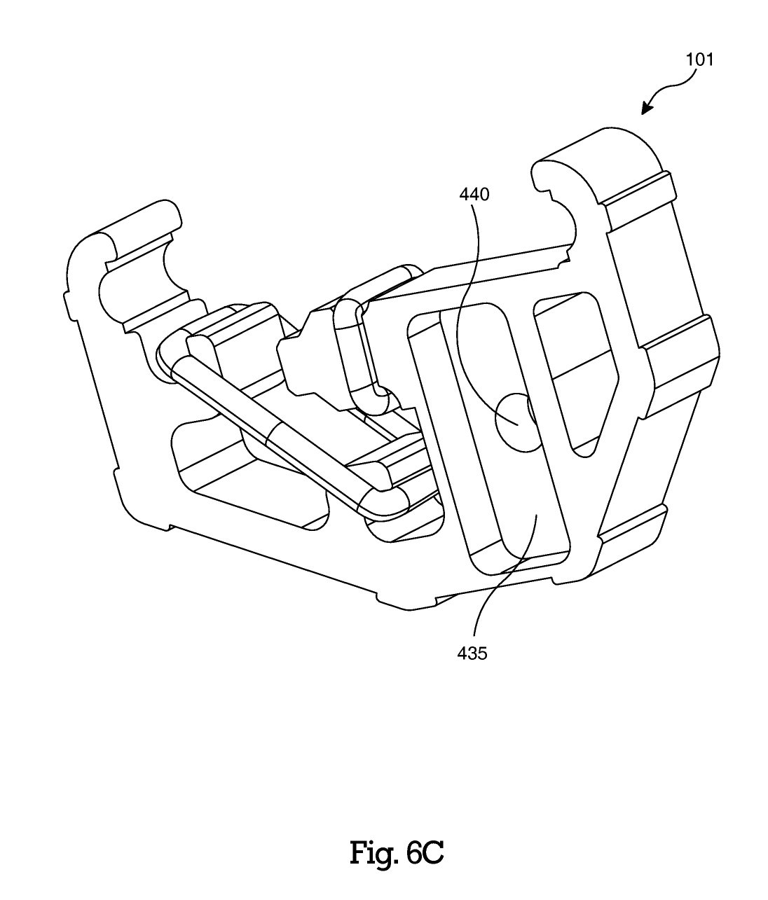

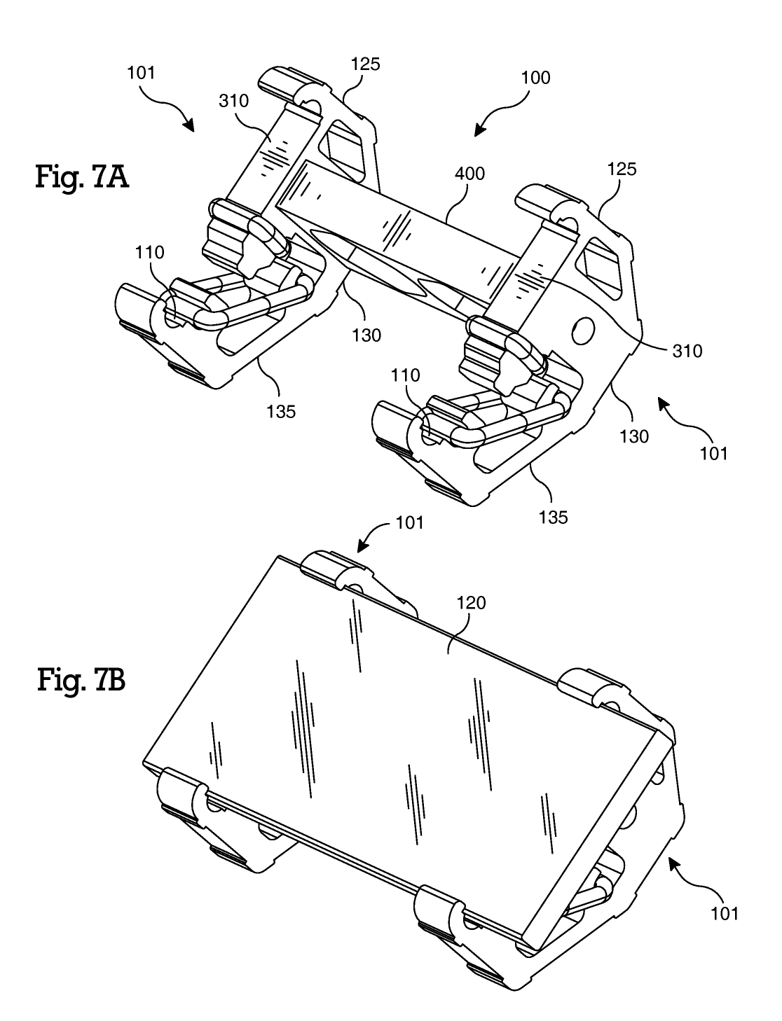

Certain embodiments, as seen in FIG. 7A and FIG. 7B, comprise a plurality of gripping devices 101 interconnected by a connecting device 400 affixed to the gripping devices 101. In certain embodiments, a first gripping device 101 is affixed to a first distal end of a connecting device 400. A second gripping device 101 is affixed to a second distal end of a connecting device 400. The first gripping device 101 and the second gripping device 101 are attached to the connecting device 400 in such a configuration that surfaces of the first gripping device 101 align with corresponding surfaces of the second gripping device 101. Such surfaces include, but are not limited to, a perpendicular viewing surface 125, a parallel viewing surface 130, angled viewing surface 135 or surfaces associated with a recess 110 or a protrusion recess 310. In such embodiments, the mobile electronic device carrying apparatus 100 is attached to a mobile electronic device 120 such that the first gripping device 101 engages a first edge of a mobile electronic device 120 with a first gripping element 105 and engages a second edge of a mobile electronic device 120 with a second gripping element 105. A first gripping element 105 of a second gripping device 101 engages the first edge of the mobile electronic device 120 with a first gripping element 105 and engages the second edge of the mobile electronic device 120 with a second gripping element 105. A connecting device 400 interconnects the first gripping device 101 and the second connecting device 101. It will be appreciated that the fixation between a connecting device 400 and a gripping device 101 comprises the use of fastening hardware, material welding, adhesives, single-form manufacturing processes or other attachment strategies known to those skilled in the art. Certain embodiments of the invention, as shown in FIG. 6B and FIG. 6C, comprise a gripping device 101 having a connecting device recess 435. The connecting device recess is configured to receive the profile of a connecting device 400. In such embodiments, a portion of a distal end of the connecting device 400 indexes into the connecting device recess 435. Furthermore, the connecting device recess 435 of certain embodiments comprises a fastening aperture 440 extending through the body of the associated gripping device. A fastening aperture 440 provides a pathway for a fastener, such as a screw, to be placed through the gripping device 101 and into a distal end of a connecting device 400. The use of a fastener in conjunction with a connecting device 400, and gripping device 101 having a gripping device recess 435 provides linear and rotational constraint between the gripping device 101 and the connecting device 400.

In certain embodiments, as shown in FIG. 7A and FIG. 7B, a mobile electronic device carrying apparatus 100 is disposed within a mobile electronic device 120 by slidably affixing the mobile electronic device carrying apparatus 100 to the mobile electronic device 120. When slidably affixed, a first gripping element 105 and a second gripping element 105 of a first gripping device 101 engage opposing surfaces of a mobile electronic device. When the mobile electronic device 120 is further slidably engaged into the mobile electronic device carrying apparatus 100, a first gripping element 105 and a second gripping element 105 of a second gripping device 101 engage opposing surfaces of a mobile electronic device. In other embodiments, a gripping element 105 allows deflection, thus permitting the attachment of a mobile electronic device carrying apparatus 100 with a mobile electronic device 120 in a snap-in operation. In such embodiments, a first step comprises a first surface of a mobile electronic device 120 engaged with a first recess 110 of a first gripping device 101 and a first recess 110 of a second gripping device 101. A second step comprises rotating a second surface of the mobile electronic device 120, opposite the first surface, to contact a second gripping element 105 of a first gripping device 101 and a second gripping element 105 of a second gripping device 101. A third step comprises adding pressure to the mobile electronic device 120 to deflect the gripping device 101 at the maximum flex portion 202 and engaging the tensioning device 220. The deflection of the gripping device 101 allows the second surface of the mobile electronic device to pass the second gripping element of the first gripping device 101 and the second gripping element of the second gripping device 101. This engages the mobile electronic device with the second recess 110 of the first gripping device 101 and the second recess 110 of the second gripping device 101.

Certain embodiments of the invention comprise a gripping element 101, as shown in FIG. 1. The gripping element distance 115 is equal to the distance between opposing first and second surfaces of a mobile electronic device 120. In other embodiments, the gripping element distance 115 is less than the distance between opposing first and second surfaces of a mobile electronic device 120 such that the attachment of a gripping device 101 to a mobile electronic device creates flexion in the gripping device 101 at the maximum flex portion 202. This further serves to engage the tensioning device 220. This flexion of the max flex portion 202 and engagement of the tensioning device 220, creates higher friction to prevent the accidental detachment of the mobile electronic device 120 from a gripping device 101.

In certain embodiments, a connecting device 400, as seen in FIG. 6A and FIG. 6B, further comprises a grasping feature 410 allowing a user to use one or more fingers interacting with the grasping feature 400 for further manual control. A grasping feature 410 will be appreciated to comprise a feature for direct engagement of a user's finger or other portion of their hand. This increased control provides added control for a user when handling or manipulating a connecting device 400, mobile electronic device carrying apparatus 100 or mobile electronic device 120 attached to the mobile electronic device carrying apparatus 100 as seen in FIG. 7A and FIG. 7B. Once again referencing FIG. 6A and FIG. 6B, certain embodiments comprise an aperture through the connecting device 400. It will be appreciated that a length 415 of a grasping feature does not exceed a length 425 of a connecting device, and a width 420 of a grasping feature does not exceed a width 430 of a connecting device. In certain embodiments, a grasping feature 410 comprises a tapered oblong form with a first radius at a first distal end of the grasping feature 410, and a second radius at a second distal end of the grasping feature 410. It will be appreciated that although round and oblong grasping features 410 comprising an aperture are illustrated in FIG. 6A and FIG. 6B, a grasping feature 410 other geometric forms of a grasping feature 410, although not explicitly disclosed, are in keeping with the scope and spirit of the present invention.

A gripping device of certain embodiments is configured to mate with a particular mobile electronic device. Alternative dimensions and angles associated with various embodiments include, but are not limited to the sizes provided in Table 1 and Table 2, referencing FIG. 8A and FIG. 8B.

TABLE 1

| | 102 | 103 | 115 | 116 | 140A | 140B |
|---|---|---|---|---|---|---|
| FIG. 8A Config. 1 | 8.94 | 4.55 | 7.19 | 8.08 | 25° | 52° |
| (cm) | | | | | | |
| FIG. 8A Config. 1 | 3.52 | 1.79 | 2.83 | 3.18 | 25° | 52° |
| (in) | | | | | | |
| FIG. 8A Config. 2 | 8.94 | 4.55 | 5.41 | 6.15 | 25° | 52° |
| (cm) | | | | | | |
| FIG. 8A Config. 2 | 3.52 | 1.79 | 2.13 | 2.42 | 25° | 52° |
| (in) | | | | | | |
| FIG. 8A Config. 3 | 7.85 | 4.39 | 6.12 | 6.99 | 26° | 52° |
| (cm) | | | | | | |
| FIG. 8A Config. 3 | 3.09 | 1.73 | 2.41 | 2.75 | 26° | 52° |
| (in) | | | | | | |
| FIG. 8B Config. 1 | 18.0594 | 7.7216 | 16.3068 | 16.891 | 29° | 39° |
| (cm) | | | | | | |
| FIG. 8B Config. 1 | 7.11 | 3.04 | 6.42 | 6.65 | 29° | 39° |
| (in) | | | | | | |
| FIG. 8B Config. 2 | 14.66 | 5.97 | 12.90 | 13.54 | 30° | 43° |
| (cm) | | | | | | |
| FIG. 8B Config. 2 | 5.77 | 2.35 | 5.08 | 5.33 | 30° | 43° |
| (in) | | | | | | |

TABLE 2

| | 415A | 415B | 420 | 425 | 430 | 436 | 437 | 441 |
|---|---|---|---|---|---|---|---|---|
| FIG. 8A Config. 1 (cm) | 3.12 | 0.00 | 2.41 | 10.49 | 2.87 | 1.30 | 2.87 | 0.64 |
| FIG. 8A Config. 1 (in) | 1.23 | | 0.95 | 4.13 | 1.13 | 0.51 | 1.13 | 0.25 |
| FIG. 8A Config. 2 (cm) | 3.61 | | 2.62 | 9.37 | 2.87 | 1.30 | 2.87 | 0.64 |
| FIG. 8A Config. 2 (in) | 1.42 | | 1.03 | 3.69 | 1.13 | 0.51 | 1.13 | 0.25 |
| FIG. 8A Config. 3 (cm) | 3.61 | | 2.57 | 9.37 | 2.87 | 1.30 | 2.87 | 0.64 |
| FIG. 8A Config. 3 (in) | 1.42 | | 1.01 | 3.69 | 1.13 | 0.51 | 1.13 | 0.25 |
| FIG. 8B Config. 1 (cm) | 4.8768 | 4.2418 | 2.3876 | 17.145 | 2.87 | 1.30 | 2.87 | 0.64 |
| FIG. 8B Config. 1 (in) | 1.92 | 1.67 | 0.94 | 6.75 | 1.13 | 0.51 | 1.13 | 0.25 |
| FIG. 8B Config. 2 (cm) | 4.88 | 3.10 | 2.39 | 13.67 | 2.87 | 1.30 | 2.87 | 0.64 |
| FIG. 8B Config. 2 (in) | 1.92 | 1.22 | 0.94 | 5.38 | 1.13 | 0.51 | 1.13 | 0.25 |

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the spirit or central characteristics thereof. The present examples and embodiments, therefore, are to be considered in all respects as illustrative and not restrictive, and the invention is not to be limited to the details given herein. The terms “first,” “second,” “top,” “bottom,” etc., as used herein, are intended for illustrative purposes only and do not limit the embodiments in any way. Additionally, the term “plurality,” as used herein, indicates any number greater than one, either disjunctively or conjunctively, as necessary, up to an infinite number. Further, “Providing” an article or apparatus, as used herein, refers broadly to making the article available or accessible for future actions to be performed on the article, and does not connote that the party providing the article has manufactured, produced, or supplied the article or that the party providing the article has ownership or control of the article. Accordingly, while specific embodiments have been illustrated and described, numerous modifications come to mind without significantly departing from the spirit of the invention and the scope of protection is only limited by the scope of the accompanying Claims.

What is claimed:

1. A mobile electronic device carrying apparatus comprising:
a first gripping device comprising a first gripping element, and a second gripping element;
a second gripping device comprising a first gripping element, and a second gripping element;
a connecting device;
a first distal end of the connecting device affixed to a first side of the first gripping device;
a second distal end of the connecting device affixed to a first side of the second gripping device;
the first gripping element of the first gripping device and the first gripping element of the second gripping device consistent with a first axis;
the second gripping element of the first gripping device and the second gripping element of the second gripping device consistent with a second axis; and
the first axis coplanar with the second axis,
wherein the disposal of a mobile electronic device within the apparatus disposes the first gripping element of the first gripping device and the first gripping element of the second gripping device in contact with a first side of the mobile electronic device, and
a second gripping element of the first gripping device and the second gripping element of the second gripping device in contact with a second side of the mobile electronic device.

2. The apparatus of claim 1, wherein the the gripping elements are hook features.

3. The apparatus of claim 2 wherein the hook features further comprise a recess.

4. The apparatus of claim 3, wherein the the recesses of the hook features further comprises a protrusion recess.

5. The apparatus of claim 1 wherein, the gripping devices further comprise a flex relief.

6. The apparatus of claim 1 wherein, the gripping devices further comprise a tensioning feature.

7. The apparatus of claim 1 wherein, the gripping devices further comprise an anti-slide feature.

8. The apparatus of claim 1 wherein, the first gripping device further comprises a connecting device recess in the first side of the first gripping device configured to receive the first distal end of the connecting device; and
the second gripping device further comprises a connecting device recess in the first side of the second gripping device configured to receive the second distal end of the connecting device.

9. The apparatus of claim 1 wherein, the second gripping device comprises a form that is a mirror image of the first gripping device.

10. The apparatus of claim 1 wherein, the first distal end of the connecting device having mechanical fixation to the connecting device recess of the first gripping device; and
the second distal end of the connecting device having mechanical fixation to the connecting device recess of the second gripping device.

11. A mobile electronic device carrying apparatus comprising:
a first gripping device comprising a first gripping element, and a second gripping element;
the first gripping device further comprising a first hook feature and a second hook feature, the first hook feature having a recess and a protrusion recess, and the second hook feature having a recess and a protrusion recess;
the first gripping device further comprising a flex relief, tensioning feature, anti-slide feature and connecting device recess;
the second gripping device further comprising a first hook feature and a second hook feature, the first hook feature having a recess and a protrusion recess, and the second hook feature having a recess and a protrusion recess;
the second gripping device further comprising a flex relief, tensioning feature and anti-slide feature and connecting device recess;
the first gripping device having a form that is a mirror image of the second gripping device;
a connecting device;
the connecting device recess of the first gripping device having a profile configured to mate with a first distal end of the connecting device;
the first distal end of the connecting device having mechanical fixation to the connecting device recess of the first gripping device;
the connecting device recess of the second gripping device having a profile configured to mate with a second distal end of the connecting device;
the second distal end of the connecting device having mechanical fixation to the connecting device recess of the second gripping device.
